(19) United States
(12) Patent Application Publication
(10) Pub. No.: US 2024/0177246 A1
(43) Pub. Date: May 30, 2024

(54) SYSTEMS, DEVICES AND METHODS FOR NFT-BASED MEMBERSHIP IN DIGITAL CLUBS AND COMMUNITIES

(71) Applicant: John Clarke Jackson, Bethesda, MD (US)

(72) Inventor: John Clarke Jackson, Bethesda, MD (US)

(21) Appl. No.: 18/058,966

(22) Filed: Nov. 28, 2022

(51) Int. Cl. G06Q 50/00; G06F 16/23; G06Q 20/38

(52) U.S. Cl. CPC G06Q 50/01; G06F 16/2365; G06Q 20/389

(57) ABSTRACT

Certain exemplary embodiments can provide systems and/or methods that can include installing software on a server and/or on one or more information devices, the software adapted to search for data regarding one or more clubs, club memberships and/or NFTs. Such software further adapted to store, transmit, deliver and/or otherwise make available such data. Such software further adapted to enable the user of such information device to purchase a membership in such club and/or an NFT representing such a membership in such a club. Such software further adapted to programmatically adjust the minimum price for subsequent new memberships and/or membership NFTs. Such software further adapted to mint such membership NFTs. Such software further adapted to transfer such membership NFTs to such user. Such software further adapted to enable the user of such information device to interact with data and/or other users associated with such clubs and/or club memberships. Such software further adapted to control access to such data and/or such interaction based on one or more NFTs owned by such user of such information device.

### CROSS-REFERENCE TO RELATED APPLICATION

This application claims priority to, and incorporates by reference herein in its entirety, pending U.S. Provisional Patent Application 63/264,694, filed Nov. 30, 2021.

### FIELD OF THE INVENTION

The present invention relates to novel systems and methods for the use of blockchain non-fungible tokens (NFTs) to grant membership in online and/or digital clubs and/or communities. More particularly, the invention relates to the minting, pricing, sale, resale and display of such membership NFTs. Additionally, the invention relates to incorporation of such membership NFTs into the process of granting access to and/or privileges within such a digital club and/or community.

### BACKGROUND

The market for selling and reselling collectible blockchain non-fungible tokens (NFTs) has boomed recently and the level of interest, reflected in the demand for such NFTs, raises the possibility of creating communities of such NFT holders to promote long-term engagement beyond the immediate buzz of an NFT drop.

For corporate brands in particular, the ability to create engaged communities among holders of brand-related NFTs can provide significant enduring value beyond the initial NFT drop itself.

However, minting such NFTs in advance can be expensive particularly when such NFTs are minted from large and/or disparate collections.

Additionally, determining the initial price and available quantity for such NFT drops presents challenges when attempting to maximize the supply and demand curve, resulting in the loss of revenue for the collection owner when not set to optimal values. This issue is exacerbated when such NFTs are minted from large and/or disparate collections where demand may be unknown and/or uneven across the collection.

Furthermore, the enforced scarcity inherent in driving NFT valuations can be directly at odds with the larger membership numbers often desired to build vibrant communities.

Therefore, a need exists for novel systems and methods to mint NFTs on demand from a collection.

Additionally, a need exists for novel systems and methods to connect NFT ownership to digital club and/or community membership, access and/or privileges.

Additionally, a need exists for novel systems and methods that allow for the granting of membership in, access to and/or privileges within one or more digital clubs and/or communities based on the ownership of one or more NFTs.

Additionally, a need exists for novel systems and methods that allow for the organization of such clubs, membership and/or NFTs based on level, hierarchy, taxonomy, chronology and/or similar method within a particular collection and/or across multiple collections.

Additionally, a need exists for novel systems and methods that allow for the granting membership in, access to and/or privileges within one or more digital clubs and/or communities to such NFT holders based on such organization.

Furthermore, a need exists for novel systems and methods that automatically adjust the minimum sale price for each new NFT minted in a series associated with a particular piece of content, collection, digital club and/or community.

### BRIEF SUMMARY OF THE INVENTION

Certain exemplary embodiments can provide systems and/or methods to mint NFTs on demand.

Certain exemplary embodiments can provide systems and/or methods to connect NFT ownership to digital club and/or community membership, access and/or privileges.

Certain exemplary embodiments can enable the granting of membership in, access to and/or privileges within one or more digital clubs and/or communities based on the ownership of one or more NFTs.

Certain exemplary embodiments can enable the organization of such clubs, membership and/or NFTs based on level, hierarchy, taxonomy, chronology and/or similar method within a particular collection and/or across multiple collections.

Certain exemplary embodiments can enable the granting membership in, access to and/or privileges within one or more digital clubs and/or communities to such NFT holders based on such organization.

Certain exemplary embodiments can enable the automatic adjustment of the minimum sale price for each new NFT minted in a series associated with a particular piece of content, collection, digital club and/or community.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is an exemplary block diagram of an exemplary embodiment of a system;

FIG. 2 is an exemplary block diagram of an exemplary embodiment of a system;

FIG. 3 is an exemplary block diagram of an exemplary embodiment of a system;

FIG. 4 is an exemplary flowchart of an exemplary embodiment of a method;

FIG. 5 is an exemplary flowchart of an exemplary embodiment of a method;

FIG. 6 is an exemplary flowchart of an exemplary embodiment of a method;

FIG. 7 is an exemplary flowchart of an exemplary embodiment of a method;

FIG. 8 is an exemplary block diagram of an exemplary embodiment of a system;

FIG. 9 is an exemplary block diagram of an exemplary embodiment of a system;

FIG. 10 is an exemplary block diagram of an exemplary embodiment of a system; and

FIG. 11 is an exemplary block diagram of an exemplary embodiment of a system.

### DETAILED DESCRIPTION OF THE INVENTION

Certain exemplary embodiments can provide systems and/or methods that can include installing software 104, 106, 204, 206 on a server, the software adapted to find, list, filter and/or otherwise search for data 105, 107, 207 regarding one or more clubs in one or more catalogs. Such software further adapted to store, transmit, deliver and/or otherwise make available such club data.

Certain exemplary embodiments can provide systems and/or methods that can include installing software 108, 208, 303 on a server, the software adapted to find, list, filter and/or otherwise search for data 109, 209, 304 regarding one or more memberships and/or users in one or more clubs. Such software further adapted to store, transmit, deliver and/or otherwise make available such membership and/or membership data, including but not limited to data associated with membership NFTs.

Certain exemplary embodiments can provide systems and/or methods that can include sending software 103, 203, 303 to an information device 102, 202, 302 the software adapted to enable the user of such information device 101, 201, 301 to search for and/or receive and/or retrieve data regarding one or more such memberships and/or clubs. Such software further adapted to display, present, render and/or otherwise make available such membership and/or club data, including but not limited to data associated with membership NFTs.

Certain exemplary embodiments can receive and/or retrieve data regarding actual and/or potential clubs in one or more collections from a list of such actual and/or potential clubs stored in a database and/or similar storage system 105, 107; such actual and/or potential club data including but not limited to data associated with people, places, events, songs, movies, TV shows, books, articles, sports teams, videos, photos, games, plants, animals, minerals, artifacts, artwork, domain names, social media accounts, social media posts and/or URLs.

Certain exemplary embodiments can receive and/or retrieve data regarding actual and/or potential clubs in one or more collections from a list of such actual and/or potential clubs derived programmatically using one or more rules, formulas, limits, constraints, calculations, routines, logic and/or similar methods 205; such actual and/or potential club data including but not limited to data associated with dates, times, numbers, coordinates and/or value permutations.

Certain exemplary embodiments can send input parameters to such programmatic methods, such parameters consisting of one dimensional and/or multidimensional values 401.

Certain exemplary embodiments can test each input parameter value against validation rules 402.

Certain exemplary embodiments can attempt fix, correct and/or repair invalid input parameter values 403.

Certain exemplary embodiments can create a validation pattern based on one or more input parameters 404.

Certain exemplary embodiments can test such validation pattern against list of permitted patterns 405.

Certain exemplary embodiments can create a unique club key and/or similar club identifier based on one or more input parameters 406.

Certain exemplary embodiments can determine if a club has already been created using such club key 407.

Certain exemplary embodiments can retrieve and return club data regarding if such a club has already been created using such club key 408.

Certain exemplary embodiments can create such club using such club key and return such club data if such club has not already been created using such club key 408.

Certain exemplary embodiments can provide systems and/or methods that can include sending software 305 to an information device 302, the software adapted to enable the user of such information device 301 to purchase, buy, bid for and/or otherwise buy and/or offer to buy a membership in such club and/or an NFT representing such a membership in such a club. Such software further adapted to display, present, render and/or otherwise make available data relating to such purchase and/or bid.

Certain exemplary embodiments can enable the establishment of a minimum price for the first such membership and/or membership NFT in such a club 501.

Certain exemplary embodiments can enable the establishment of one or more rules, formulas, calculations, routines, logic and/or similar methods to programmatically adjust the minimum price for subsequent new memberships and/or membership NFTs after the first such membership and/or membership NFT 502.

Certain exemplary embodiments can allow for the sale of the first such membership and/or membership NFT for a price greater than or equal to such minimum price established for the first membership and/or membership NFT 503.

Certain exemplary embodiments can programmatically establish the minimum price for the second membership and/or membership NFT by applying such rules, formulas, calculations, routines, logic and/or similar methods using as an input such sale price of such first membership and/or membership NFT 504.

Certain exemplary embodiments can allow for the sale of the second such membership and/or membership NFT for a price greater than or equal to such minimum price established for the second membership and/or membership NFT 505.

Certain exemplary embodiments can programmatically establish the minimum price for the third membership and/or membership NFT by applying such rules, formulas, calculations, routines, logic and/or similar methods using as an input such sale price of such second membership and/or membership NFT 506.

Certain exemplary embodiments can allow for the resale of the first such membership and/or membership NFT for a price greater than or equal to such minimum price established for such third membership and/or membership NFT 507.

Certain exemplary embodiments can programmatically establish a new minimum price for such third membership and/or membership NFT by applying such rules, formulas, calculations, routines, logic and/or similar methods using as an input such resale price of such first membership and/or membership NFT 508.

Certain exemplary embodiments can extend such programmatically established minimum pricing beyond such first, second and third membership and/or membership NFTs.

Certain exemplary embodiments can receive data regarding a club using a club ID, club key and/or other unique club identifier 601.

Certain exemplary embodiments can retrieve the number of previously created memberships for such club or zero if no memberships have been previously created 602.

Certain exemplary embodiments can create a new membership for such club, such membership having a membership number equal to one (1) more than such number of previously created memberships for such club 603.

Certain exemplary embodiments can make such new membership available for sale through a marketplace, catalog, store, ecommerce site and/or other similar method 305, 306, 604.

Certain exemplary embodiments can receive payment from a user for such new membership 309, 605.

Certain exemplary embodiments can mint a new NFT for such new membership in response to receipt of such payment from such user 308, 606.

Certain exemplary embodiments can transfer such new NFT to such user 310, 607.

Certain exemplary embodiments can record such sale of such new NFT completed upon such transfer of such new NFT to such user 608.

Certain exemplary embodiments can make such new membership available for auction sale through a marketplace, catalog, store, ecommerce site and/or other similar method 307, 704.

Certain exemplary embodiments can receive a first bid from a user for such new membership 705.

Certain exemplary embodiments can mint a new NFT for such new membership in response to receipt of such first bid from such user 706.

Certain exemplary embodiments can set the auction end time for auction sale for such new membership 707.

Certain exemplary embodiments can set such auction end time to be a specific duration after the time of receipt of such first bid from such user for such new membership.

Certain exemplary embodiments can set such auction end time to be a specific duration after the time of minting of such new NFT for such new membership.

Certain exemplary embodiments can receive one or more additional bids for such new membership from one or more user after such first bid for such new membership 708.

Certain exemplary embodiments can end such auction for such new membership at such auction end time 709.

Certain exemplary embodiments can determine the winning bid of such auction for such new membership 709.

Certain exemplary embodiments can receive payment from the user who submitted such winning bid for such new membership 710.

Certain exemplary embodiments can transfer such new NFT to such user 711.

Certain exemplary embodiments can record such auction of such new NFT completed upon such transfer of such new NFT to such user 712.

Certain exemplary embodiments can enable such user to receive such membership and/or membership NFT upon and/or after and/or related to the purchase of a product and/or service by such user.

Certain exemplary embodiments can enable such user to receive such membership and/or membership NFT upon and/or after and/or related to the attendance of an event and/or the purchase of a ticket by such user.

Certain exemplary embodiments can enable such user to receive such membership and/or membership NFT upon and/or after and/or related to the completion of a task by such user.

Certain exemplary embodiments can enable such user to receive such membership and/or membership NFT upon and/or after and/or related to the achievement of a goal, rank, level and/or other similar such accomplishment by such user.

Certain exemplary embodiments can enable such user to receive such membership and/or membership NFT upon use, submission, redemption and/or other form of delivery and/or verification of a QR code, text code, link and/or other similar method.

Certain exemplary embodiments can provide systems and/or methods that can include sending software 803, 903, 1003 to an information device 802, 902, 1002, the software adapted to enable the user of such information device 801, 901, 1001 to access, view, search, filter, receive, send, post, upload, submit, create, update, modify, replace, archive, delete and/or otherwise interact with data regarding one or more such clubs, communities, memberships, NFTs and/or users. Such software further adapted to display, present, render and/or otherwise make available such club, community, membership, NFT and/or user data.

Certain exemplary embodiments can provide systems and/or methods that can include installing software 803, 804, 903, 904, 1003, 1004 on a server, the software adapted to access, search, filter, receive, send, post, upload, submit, create, update, modify, replace, archive, delete and/or otherwise interact with data 808, 909, 1010 regarding one or more such clubs, communities, memberships, NFTs and/or users. Such software further adapted to store, transmit, deliver and/or otherwise make available such club, community, membership, NFT and/or user data.

Certain exemplary embodiments can allow, grant, permit, deny, prohibit, restrict, limit and/or otherwise control access to such data and/or such interaction with such data regarding one or more such clubs, communities, memberships, NFTs and/or users based on privileges, information, authorization, account, level, permissions and/or other such data associated with and/or pertaining to such user of such information device, such control applied to all and/or to one or more individual interactions and/or datum.

Certain exemplary embodiments can allow, grant, permit, deny, prohibit, restrict, limit and/or otherwise control access to such data and/or such interaction with such data regarding one or more such clubs and/or communities based on one or more such memberships held by, owned by and/or otherwise associated with and/or pertaining to such user of such information device, such control applied to all and/or to one or more individual interactions and/or datum.

Certain exemplary embodiments can allow, grant, permit, deny, prohibit, restrict, limit and/or otherwise control access to such data and/or such interaction with such data regarding one or more such clubs, communities, memberships, NFTs and/or users based on one or more NFTs, including but not limited to such membership NFTs 805, 905, 906, 1005, held by, owned by and/or otherwise associated with and/or pertaining to such user of such information device, such control applied to all and/or to one or more individual interactions and/or datum.

Certain exemplary embodiments can control such access to such data and/or such interaction with such data for one or more clubs, communities, memberships, NFTs and/or users based on one or more memberships and/or membership NFTs that are associated with, are memberships in and/or are otherwise connected to such clubs, communities, memberships, NFTs and/or users.

Certain exemplary embodiments can control such access to such data and/or such interaction with such data for one or more clubs, communities, memberships, NFTs and/or users based on one or more memberships and/or membership NFTs that are associated with, are memberships in and/or are otherwise connected to one or more different and/or other such clubs, communities, memberships, NFTs and/or users.

Certain exemplary embodiments can order, list, sort, connect and or otherwise organize such clubs, communities, memberships, NFTs and/or users.

Certain exemplary embodiments can order, list, sort, connect and or otherwise organize such clubs, communities, memberships, NFTs and/or users manually.

Certain exemplary embodiments can order, list, sort, connect and or otherwise organize such clubs, communities, memberships, NFTs and/or users programmatically using one or more rules, formulas, limits, constraints, calculations, routines, logic and/or similar methods.

Certain exemplary embodiments can order, list, sort, connect and or otherwise organize such clubs, communities, memberships, NFTs and/or users based on attributes, elements, information, features, analytics, statistics, memberships, dates, IDs, keys, or other such data pertaining to, associated with, connected to, linked to, attributed to and/or otherwise related to such clubs, communities, memberships, NFTs and/or users.

Certain exemplary embodiments can order, list, sort, connect and or otherwise organize such clubs, communities, memberships, NFTs and/or users using a taxonomy, hierarchy and/or similar structure.

Certain exemplary embodiments can order, list, sort, connect and or otherwise organize such clubs, communities, memberships, NFTs and/or users using a graph, network and/or similar structure.

Certain exemplary embodiments can order, list, sort, connect and or otherwise organize such clubs, communities, memberships, NFTs and/or users using parent-child relationships and/or similar structure.

Certain exemplary embodiments can recommend related clubs, communities, memberships, NFTs and/or users based on such organization.

Certain exemplary embodiments can recommend related memberships in such clubs and/or communities based on such organization.

Certain exemplary embodiments can recommend membership NFTs related to such clubs and/or communities based on such organization.

Certain exemplary embodiments can control such access to such data and/or such interaction with such data for such related, recommended and/or otherwise organized clubs, communities, memberships, NFTs and/or users based on one or more memberships and/or membership NFTs that are associated with, are memberships in and/or are otherwise connected to one or more different such clubs, communities, memberships, NFTs and/or users.

Certain exemplary embodiments can control such access to such data and/or such interaction with such data for such parent clubs, communities, memberships, NFTs and/or users based on one or more memberships and/or membership NFTs that are associated with, are memberships in and/or are otherwise connected to one or more such child clubs, communities, memberships, NFTs and/or users.

Certain exemplary embodiments can control such access to such data and/or such interaction with such data for such child clubs, communities, memberships, NFTs and/or users based on one or more memberships and/or membership NFTs that are associated with, are memberships in and/or are otherwise connected to one or more such parent clubs, communities, memberships, NFTs and/or users.

Certain exemplary embodiments can connect one such user to one or more other such users.

Certain exemplary embodiments can connect one such user to one or more other such users based on such related memberships in such clubs and/or communities.

Certain exemplary embodiments can connect one such user to one or more other such users based on such related membership NFTs in such clubs and/or communities.

Certain exemplary embodiments can automatically and/or programmatically establish such connection between such users.

Certain exemplary embodiments can manually establish such connection between such users.

Certain exemplary embodiments can allow one such user to request connection to one or more other such users.

Certain exemplary embodiments can allow such user that receives such request to deny such request, resulting in no such connection being established between such users.

Certain exemplary embodiments can allow such user that receives such request to accept such request, resulting in such connection being established between such users.

Certain exemplary embodiments can allow such connected users to communicate directly with each other, such communication including, but not limited to, text, images, audio and/or video.

Certain exemplary embodiments can enable such communication between such connected users to be synchronous, in real time and/or near real time.

Certain exemplary embodiments can enable such communication between such connected users to be asynchronous and/or not in real time and/or near real time.

Certain exemplary embodiments can enable such communication between such connected users to be private.

Certain exemplary embodiments can enable such communication between such connected users to be public.

Certain exemplary embodiments can enable such communication between such connected users to be one-way and/or broadcasted from one or more such connected users to one or more other such connected users.

Certain exemplary embodiments can enable such communication between such connected users to be two-way and/or interactive between one or more such connected users and/or one or more other such connected users.

Certain exemplary embodiments can enable such connection between such users by allowing, granting, permitting, denying, prohibiting, restricting, limiting and/or otherwise controlling access to such data and/or such interaction with such data regarding one or more such users.

Certain exemplary embodiments can apply to any organization, collection or grouping of NFTs and/or users not limited to clubs and/or communities.

Certain exemplary embodiments can apply to any NFT not limited to membership NFTs, including but not limited to NFTs associated with image, video, text and/or other content.

Certain exemplary embodiments can transfer a blockchain asset, including but not limited to one or more NFTs and/or Fungible Tokens, to a blockchain account provided by, owned by and/or connected to a user.

Certain exemplary embodiments can receive a blockchain asset, including but not limited to one or more NFTs and/or Fungible Tokens, from a blockchain account provided by, owned by and/or connected to a user.

### DRAWINGS

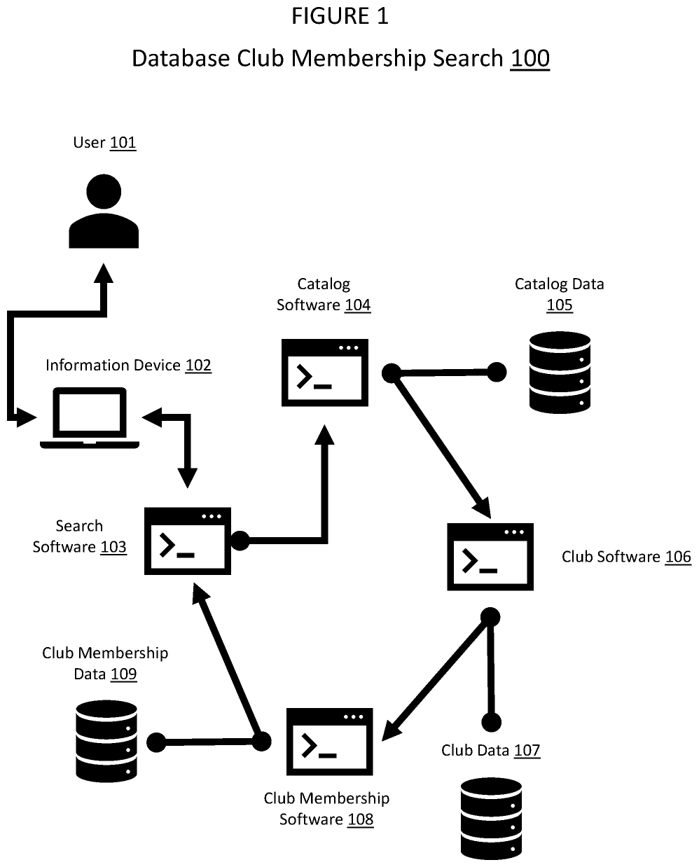

FIG. 1 is a block diagram of an exemplary embodiment of a club and/or club membership search system.

Certain exemplary embodiments can receive and/or retrieve data regarding potential clubs and/or club memberships in one or more collections from a list of such potential clubs and/or club memberships stored in a database and/or similar storage system 105, 107.

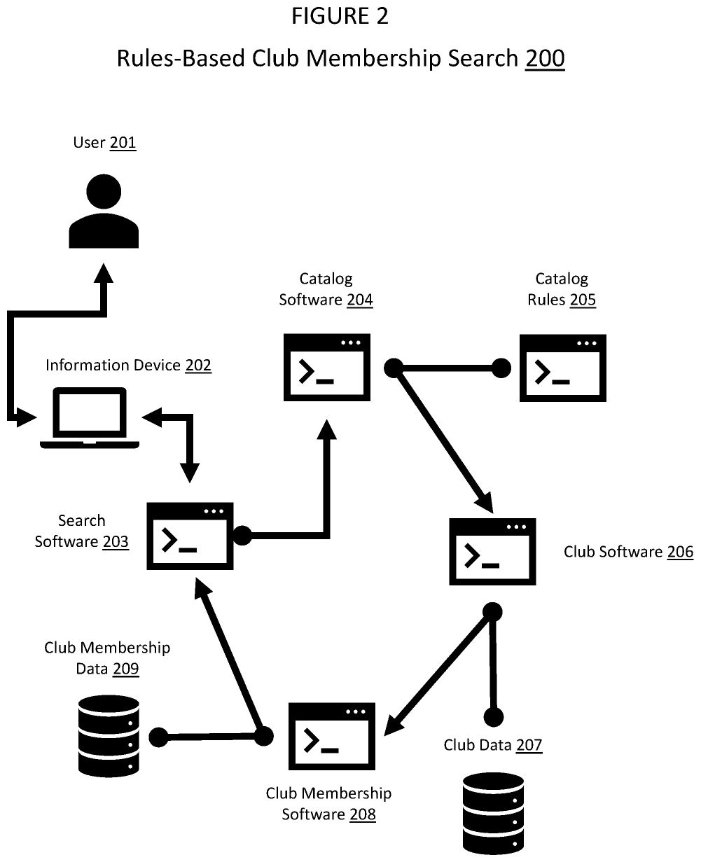

FIG. 2 is a block diagram of an exemplary embodiment of a club and/or club membership search system.

Certain exemplary embodiments can receive and/or retrieve data regarding potential clubs and/or club memberships in one or more collections from a list of such potential clubs and/or club memberships derived programmatically using one or more rules, formulas, limits, constraints, calculations, routines, logic and/or similar methods 205.

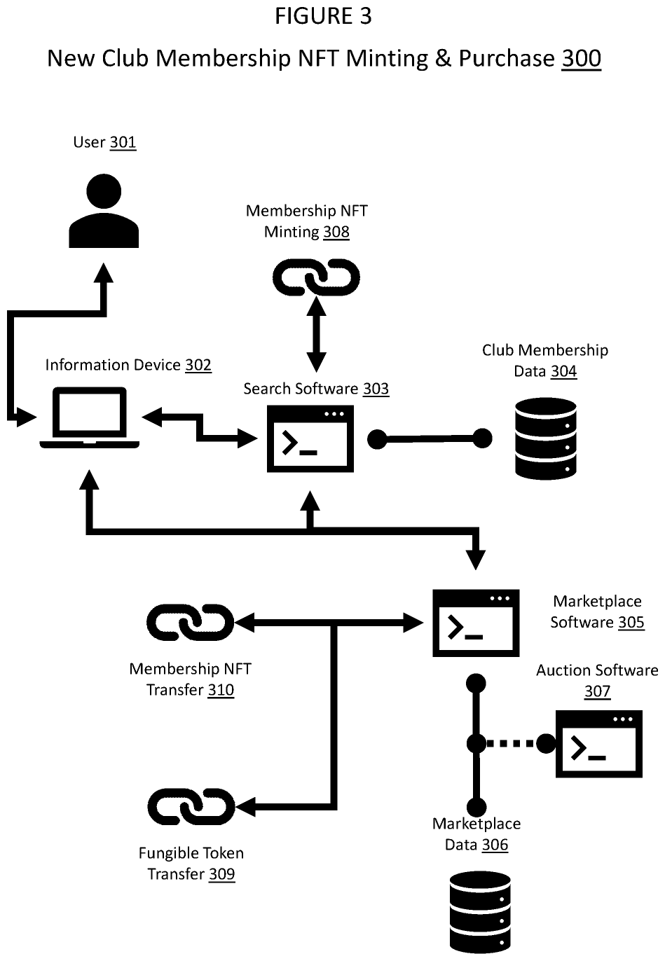

FIG. 3 is a block diagram of an exemplary embodiment of a club membership NFT minting and purchase system.

Certain exemplary embodiments can sell membership NFTs in a marketplace system 305.

Certain exemplary embodiments can sell membership NFTs through an auction system 307.

Certain exemplary embodiments can mint NFTs 308.

Certain exemplary embodiments can receive and/or transfer NFTs 310.

Certain exemplary embodiments can receive and/or transfer Fungible Tokens 309.

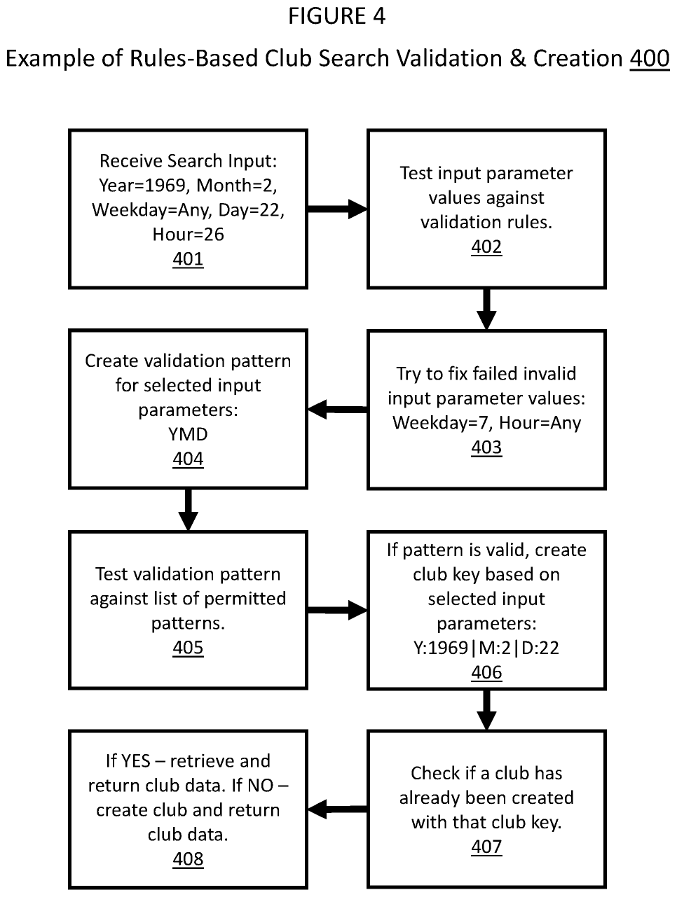

FIG. 4 is a flowchart of an exemplary embodiment of a rules-based club search validation and creation method.

Certain exemplary embodiments can receive one or more search input parameter values 401.

Certain exemplary embodiments can test and/or validate one or more input parameter values against one or more validation value lists and/or validation rules 402.

Certain exemplary embodiments can attempt to fix one or more such input parameter values that fail such validation tests 403.

Certain exemplary embodiments can create a validation pattern using one or more input parameters and/or input parameter values 404.

Certain exemplary embodiments can test such validation pattern against one or more validation value lists and/or validation rules 405.

Certain exemplary embodiments can create a club key and/or other such identifier using one or more input parameters and/or input parameter values 406.

Certain exemplary embodiments can validate if a club has already been created using such club key and/or identifier 407.

Certain exemplary embodiments can create a club using and/or store data associated with such club key and/or identifier 408.

Certain exemplary embodiments can retrieve such club and/or data associated with such club, club key and/or identifier 408.

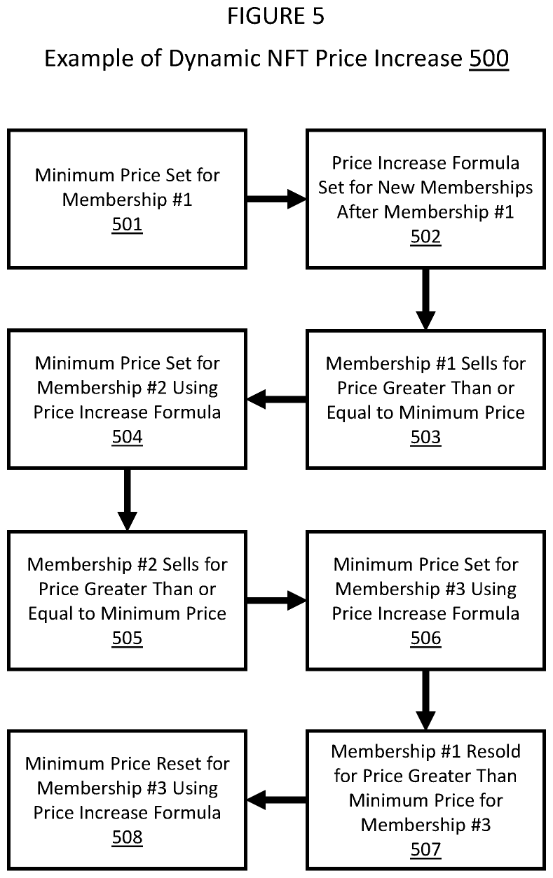

FIG. 5 a flowchart of an exemplary embodiment of a dynamic NFT price increase method.

Certain exemplary embodiments can establish a minimum price for a first membership and/or membership NFT (Membership #1) 501.

Certain exemplary embodiments can establish one or more rules, formulas, calculations, routines, logic and/or similar methods to programmatically adjust the minimum price for subsequent new memberships and/or membership NFTs after Membership #1 502.

Certain exemplary embodiments can enable the sale of such Membership #1 for a price greater than or equal to such minimum price established for Membership #1 503.

Certain exemplary embodiments can programmatically establish the minimum price for the second membership and/or membership NFT (Membership #2) by applying such rules, formulas, calculations, routines, logic and/or similar methods using as an input such sale price of Membership #1 504.

Certain exemplary embodiments can allow for the sale of such Membership #2 for a price greater than or equal to such minimum price established for Membership #2 505.

Certain exemplary embodiments can programmatically establish the minimum price for the third membership and/or membership NFT (Membership #3) by applying such rules, formulas, calculations, routines, logic and/or similar methods using as an input such sale price of such Membership #2 506.

Certain exemplary embodiments can allow for the resale of such Membership #1 for a price greater than or equal to such minimum price established for such Membership #3 before the sale of such Membership #3 507.

Certain exemplary embodiments can programmatically establish a new minimum price for such Membership #3 by applying such rules, formulas, calculations, routines, logic and/or similar methods using as an input such resale price of such Membership #1 508.

Certain exemplary embodiments can continue such similar logic, process flow and/or methodology to memberships beyond such Memberships #1, #2 and/or #3.

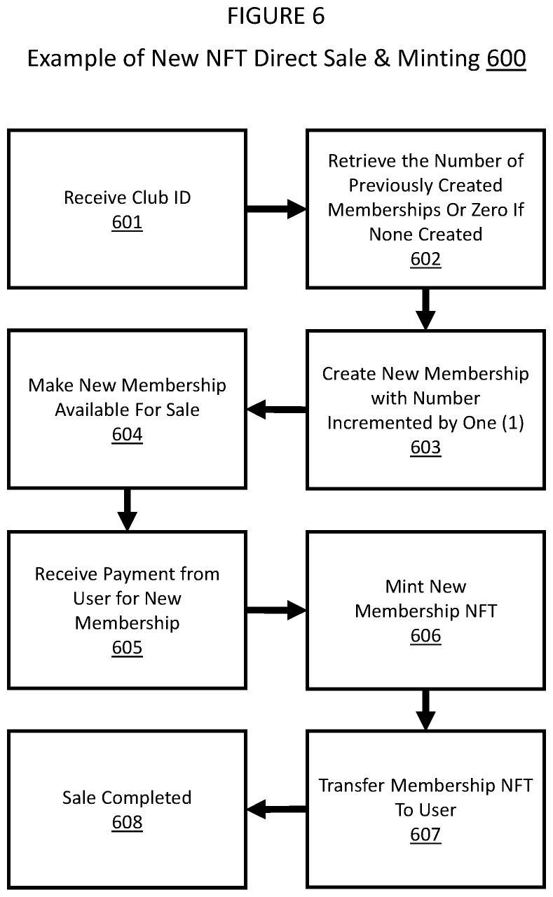

FIG. 6 is a flowchart of an exemplary embodiment of a new membership NFT direct sale and minting method.

Certain exemplary embodiments can receive a club, club key and/or other such identifier 601.

Certain exemplary embodiments can retrieve and/or return the number of previously created, sold and/or transferred memberships and/or membership NFTs associated with such club, club key and/or other such identifier 602.

Certain exemplary embodiments can retrieve and/or return zero if there are not any previously created, sold and/or transferred memberships and/or membership NFTs associated with such club, club key and/or other such identifier 602.

Certain exemplary embodiments can create a new such membership associated with such club, club key and/or other such identifier 603.

Certain exemplary embodiments can set the membership number, serial number and/or other such identifier associated with such new membership to the result of adding one (1) to such number of such previously created, sold and/or transferred membership NFTs 603.

Certain exemplary embodiments can make such new membership available for sale and/or purchase 604.

Certain exemplary embodiments can receive payment for the sale and/or purchase such new membership from a user 605.

Certain exemplary embodiments can mint a new membership NFT associated with such membership 606.

Certain exemplary embodiments can set the membership number, serial number and/or other such identifier associated with such new membership NFT to the membership number, serial number and/or other such identifier associated with such new membership 606.

Certain exemplary embodiments can transfer such new membership NFT to such user 607.

Certain exemplary embodiments can close, mark, update and/or otherwise store and/or indicate that the status of such sale and/or purchase is completed 608.

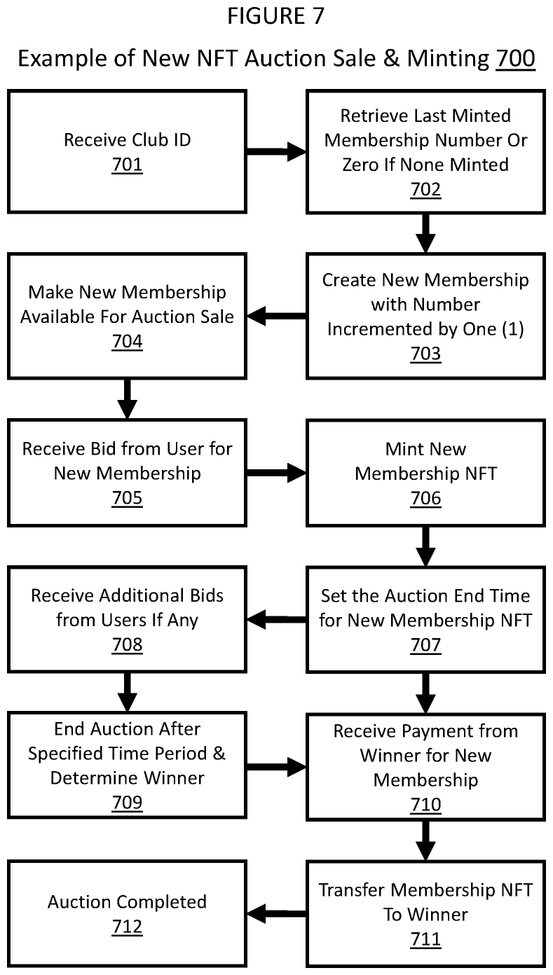

FIG. 7 is a flowchart of an exemplary embodiment of a new membership NFT auction sale and minting method.

Certain exemplary embodiments can receive a club, club key and/or other such identifier 701.

Certain exemplary embodiments can retrieve and/or return the number of previously created, sold and/or transferred memberships and/or membership NFTs associated with such club, club key and/or other such identifier 702.

Certain exemplary embodiments can retrieve and/or return zero if there are not any previously created, sold and/or transferred memberships and/or membership NFTs associated with such club, club key and/or other such identifier 702.

Certain exemplary embodiments can create a new such membership associated with such club, club key and/or other such identifier 703.

Certain exemplary embodiments can set the membership number, serial number and/or other such identifier associated with such new membership to the result of adding one (1) to such number of such previously created, sold and/or transferred membership NFTs 703.

Certain exemplary embodiments can make such new membership available for auction 704.

Certain exemplary embodiments can receive a bid for the purchase of such new membership from a user 705.

Certain exemplary embodiments can mint a new membership NFT associated with such membership 706.

Certain exemplary embodiments can mint a new membership NFT associated with such membership upon receipt of such bid.

Certain exemplary embodiments can set the membership number, serial number and/or other such identifier associated with such new membership NFT to the membership number, serial number and/or other such identifier associated with such new membership 706.

Certain exemplary embodiments can set and/or otherwise establish an end time and/or duration for such auction of such new membership 707.

Certain exemplary embodiments can receive one or more additional bids for the purchase of such new membership from one or more additional users 708.

Certain exemplary embodiments can end such auction at such end time and/or after such duration 709.

Certain exemplary embodiments can mint a new membership NFT associated with such membership upon the end of such auction.

Certain exemplary embodiments can determine which such user is the winner of such auction.

Certain exemplary embodiments can determine that such winner is the user that has the highest such bid.

Certain exemplary embodiments can mint a new membership NFT associated with such membership after determination of such winner.

Certain exemplary embodiments can receive payment for the purchase such new membership from such winner 710.

Certain exemplary embodiments can transfer such new membership NFT to such winner 711.

Certain exemplary embodiments can close, mark, update and/or otherwise store and/or indicate that the status of such auction, sale and/or purchase is completed 712.

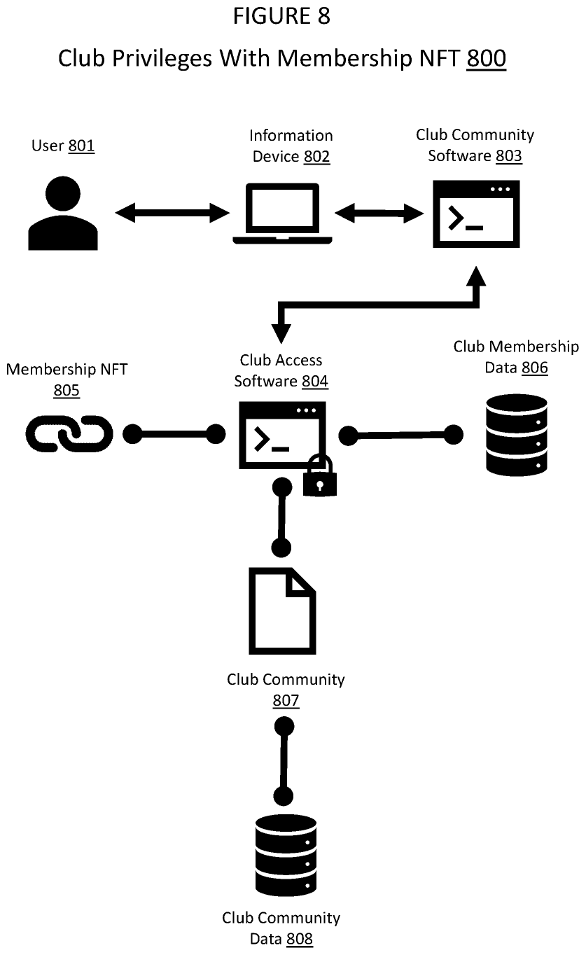

FIG. 8 is a block diagram of an exemplary embodiment of a system to assign, associate, implement and/or otherwise enforce club, community, digital, online and/or other system privileges for a user based on an NFT owned by such user.

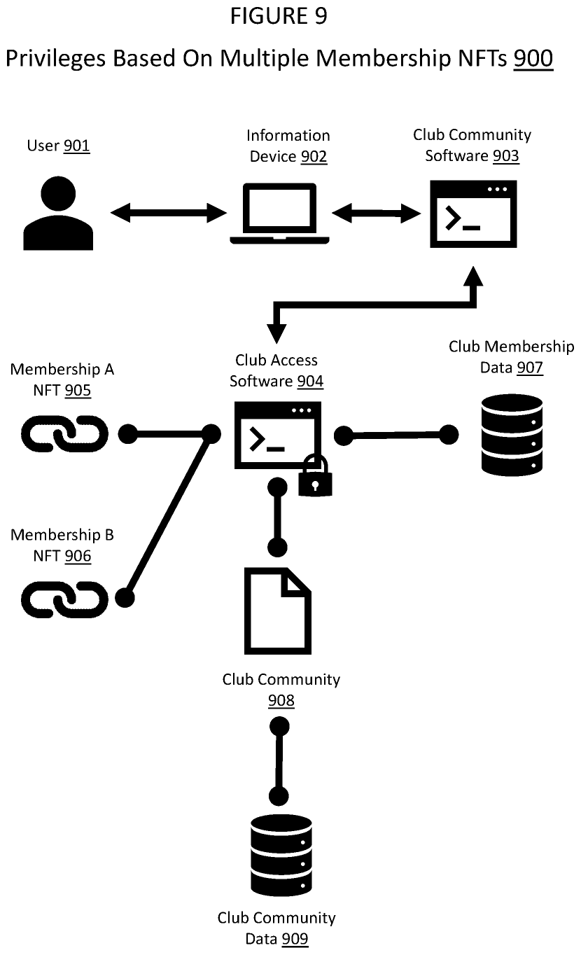

FIG. 9 is a block diagram of an exemplary embodiment of a system to assign, associate, implement and/or otherwise enforce club, community, digital, online and/or other system privileges for a user based on multiple NFTs owned by such user.

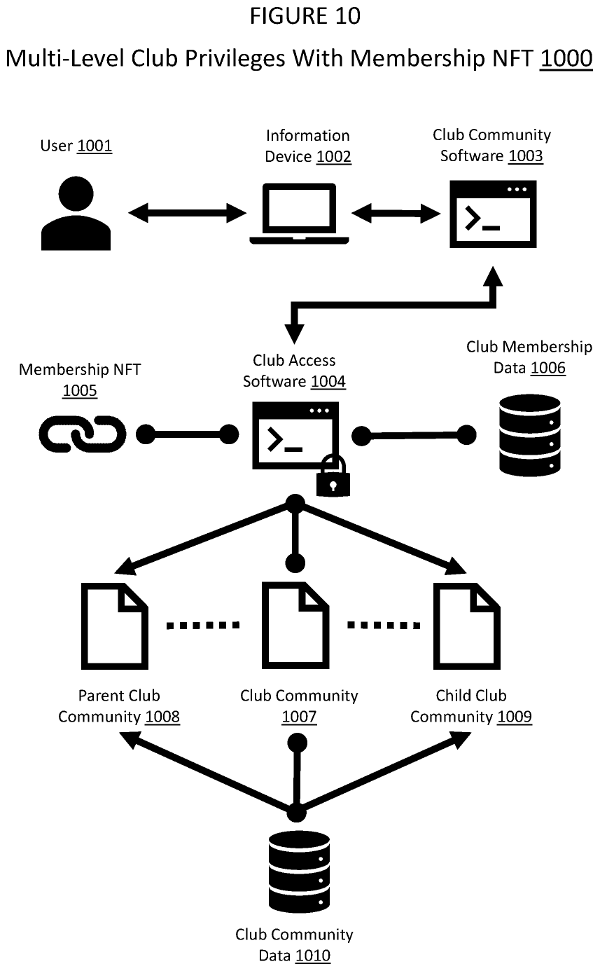

FIG. 10 is a block diagram of an exemplary embodiment of a system to assign, associate, implement and/or otherwise enforce club, community, digital, online and/or other system privileges for multiple clubs, communities, digital, online and/or other systems for a user based on an NFT owned by such user.

Certain exemplary embodiments can assign, associate, implement and/or otherwise enforce such privileges for such user based on multiple NFTs owned by such user.

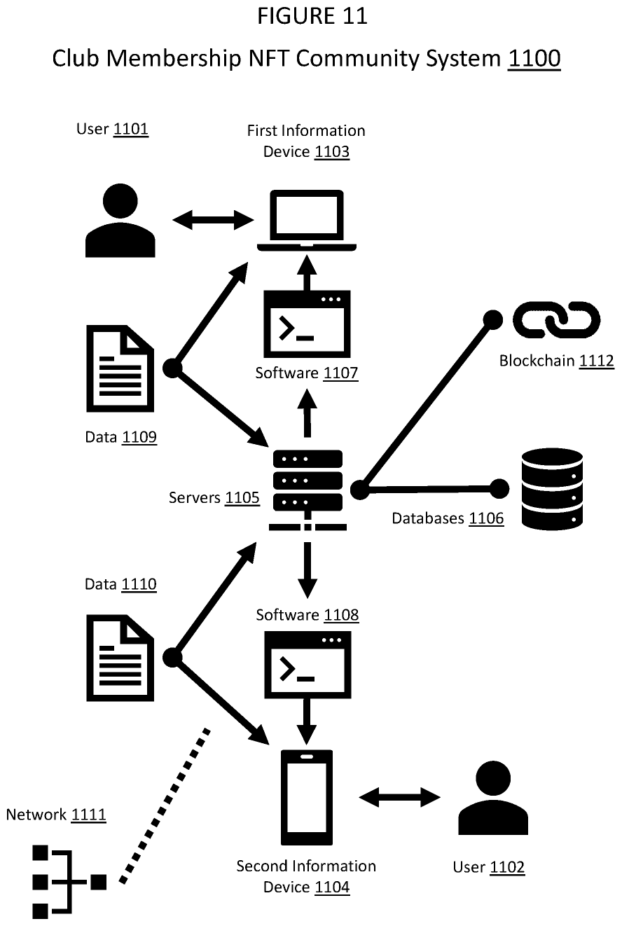

FIG. 11 is a block diagram of an exemplary embodiment of a system 1100 which can comprise any number of information devices 1103, 1104, which can be communicatively coupled via a network 1111.

Also coupled to network 1111 can be any number of servers 1105. A server can include a server software application. A server can be coupled to a data storage device, repository, and/or databases 1106. A server can include an administrator user interface and/or database management software. A server can be coupled to a blockchain system 1103.

Certain exemplary embodiments include: sending software 1107, 1108 to a first information device 1103 and a second information device 1104, the software 1107 adapted to enable the user 1101 of the first information device 1103 to post data and/or content 1109 to the server 1105; providing data and/or content 1110 to the software running on the second information device 1104, the software 1108 adapted to cause such data and/or content 1109, 1110 to be rendered via the second information device 1104.

### Definitions

When the following terms are used substantively herein, the accompanying definitions apply. These terms and definitions are presented without prejudice, and, consistent with the application, the right to redefine these terms via amendment during the prosecution of this application or any application claiming priority hereto is reserved. For the purpose of interpreting a claim of any patent that claims priority hereto, each definition in that patent functions as a clear and unambiguous disavowal of the subject matter outside of that definition.
a—at least one.
activity—an action, act, step, and/or process or portion thereof.
adapted to—made suitable or fit for a specific use or situation.
algorithm—an algorithm may include, but is not limited to, a calculation, process, set of rules, problem-solving operation, mathematical formula, software program, machine instructions, machine learning, artificial intelligence or neural network.
and/or—either in conjunction with or in alternative to.
apparatus—an appliance or device for a particular purpose.
associate—to join, connect together, and/or relate.
automatically—acting or operating in a manner essentially independent of external influence or control. For example, an automatic light switch can turn on upon “seeing” a person in its view, without the person manually operating the light switch.
backbone network—a “transit” network often made up of long-distance telephone trunk lines and/or other wired and/or wireless links such as microwave and satellite links for use in transmitting large amounts of data simultaneously between host computer systems connected to the Internet. Normal communicated data typically neither originates nor terminates in a backbone network.
blockchain—a type of database where data is stored in a chain of blocks.
Boolean logic—a complete system for logical operations.
can—is capable of, in at least some embodiments.
cause—to produce an effect.
circuit—a physical system comprising: an electrically conductive pathway and/or a communications connection established across a switching device (such as logic gates); and/or an electrically conductive pathway and/or a communications connection established across two or more switching devices comprised by a network and between corresponding end systems connected to, but not comprised by the network.
club—including but not limited to a club, community, organization, group, network, collection, association and/or similar group.
community—including but not limited to a club, community, organization, group, network, collection, association and/or similar group.
comprising—including but not limited to.
configure—to make suitable or fit for a specific use or situation. containing—including but not limited to. convert—to transform, adapt, and/or change. create—to bring into being.
data—distinct pieces of information, usually formatted in a special or predetermined way and/or organized to express concepts, and/or represented in a form suitable for processing by an information device.
data structure—an organization of a collection of data that allows the data to be manipulated effectively and/or a logical relationship among data elements that is designed to support specific data manipulation functions. A data structure can comprise meta data to describe the properties of the data structure. Examples of data structures can include: array, dictionary, graph, hash, heap, linked list, matrix, object, queue, ring, stack, tree, and/or vector.
define—to establish the outline, form, or structure of
determine—to obtain, calculate, decide, deduce, and/or ascertain.
device—a machine, manufacture, and/or collection thereof digital—non-analog and/or discrete.
device user—user of the information device.
digital—of or relating to computers, information devices, data and/or software.
estimate—to calculate and/or determine approximately and/or tentatively.
first device user—user of the first information device.
fungible token—assets on blockchain that can be equally exchanged with other such assets, for example cryptocurrency.
generate—to create, produce, give rise to, and/or bring into existence.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
having—including but not limited to.
human-machine interface—hardware and/or software adapted to render information to a user and/or receive information from the user; and/or a user interface.
including—including but not limited to.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as an iPhone and/or Galaxy-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
initialize—to prepare something for use and/or some future event.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
instructions—directions, which can be implemented as firmware and/or software, the directions adapted to perform a particular operation or function.
logic gate—a physical device adapted to perform a logical operation on one or more logic inputs and to produce a single logic output, which is manifested physically. Because the output is also a logic-level value, an output of one logic gate can connect to the input of one or more other logic gates, and via such combinations, complex operations can be performed. The logic normally performed is Boolean logic and is most commonly found in digital circuits. The most common implementations of logic gates are based on electronics using resistors, transistors, and/or diodes, and such implementations often appear in large arrays in the form of integrated circuits (a.k.a., IC's, microcircuits, microchips, silicon chips, and/or chips). It is possible, however, to create logic gates that operate based on vacuum tubes, electromagnetics (e.g., relays), mechanics (e.g., gears), fluidics, optics, chemical reactions, and/or DNA, including on a molecular scale. Each electronically-implemented logic gate typically has two inputs and one output, each having a logic level or state typically physically represented by a voltage. At any given moment, every terminal is in one of the two binary logic states (“false” (a.k.a., “low” or “0”) or “true” (a.k.a., “high” or “1”), represented by different voltage levels, yet the logic state of a terminal can, and generally does, change often, as the circuit processes data. Thus, each electronic logic gate typically requires power so that it can source and/or sink currents to achieve the correct output voltage. Typically, machine instructions are ultimately encoded into binary values of “0”'s and/or “1”s and, are typically written into and/or onto a memory device, such as a “register”, which records the binary value as a change in a physical property of the memory device, such as a change in voltage, current, charge, phase, pressure, weight, height, tension, level, gap, position, velocity, momentum, force, temperature, polarity, magnetic field, magnetic force, magnetic orientation,
reflectivity, molecular linkage, molecular weight, etc. An exemplary register might store a value of “01101100”, which encodes a total of 8 “bits” (one byte), where each value of either “0” or “1” is called a “bit” (and 8 bits are collectively called a “byte”). Note that because a binary bit can only have one of two different values (either “0” or “1”), any physical medium capable of switching between two saturated states can be used to represent a bit. Therefore, any physical system capable of representing binary bits is able to represent numerical quantities, and potentially can manipulate those numbers via particular encoded machine instructions. This is one of the basic concepts underlying digital computing. At the register and/or gate level, a computer does not treat these “0”s and “1”'s as numbers per se, but typically as voltage levels (in the case of an electronically-implemented computer), for example, a high voltage of approximately +3 volts might represent a “1” or “logical true” and a low voltage of approximately 0 volts might represent a “0” or “logical false” (or vice versa, depending on how the circuitry is designed). These high and low voltages (or other physical properties, depending on the nature of the implementation) are typically fed into a series of logic gates, which in turn, through the correct logic design, produce the physical and logical results specified by the particular encoded machine instructions. For example, if the encoding request a calculation, the logic gates might add the first two bits of the encoding together, produce a result “1” (“0″+”1″=“1”), and then write this result into another register for subsequent retrieval and reading. Or, if the encoding is a request for some kind of service, the logic gates might in turn access or write into some other registers which would in turn trigger other logic gates to initiate the requested service.
logical—a conceptual representation.
machine instructions—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine-readable medium—a physical structure from which a machine, such as an information device, computer, microprocessor, and/or controller, etc., can store and/or obtain machine-implementable instructions, data, and/or information. Examples include a memory device, punch cards, etc.
manually—by one or more people, users, and/or system administrators, including but not limited to, through the use of software sent to an information device, the software adapted for such purpose.
may—is allowed and/or permitted to, in at least some embodiments.
membership—including but not limited to a membership, affiliation, relationship and/or other similar association with a club and/or community.
membership NFT—including but not limited to an NFT associated with and/or representing a membership.
memory device—an apparatus capable of storing, sometimes permanently, machine-implementable instructions, data, and/or information, in analog and/or digital format. Examples include at least one non-volatile memory, volatile memory, register, relay, switch, Random Access Memory, RAM, Read Only Memory, ROM, flash memory, magnetic media, hard disk, floppy disk, magnetic tape, optical media, optical disk, compact disk, CD, digital versatile disk, DVD, and/or raid array, etc. The memory device can be coupled to a processor and/or can store and provide instructions adapted to be executed by processor, such as according to an embodiment disclosed herein.
method—one or more acts that are performed upon subject matter to be transformed to a different state or thing and/or are tied to a particular apparatus, said one or more acts not a fundamental principal and not pre-empting all uses of a fundamental principal.
network—a communicatively coupled plurality of nodes, communication devices, and/or information devices. Via a network, such nodes and/or devices can be linked, such as via various wireline and/or wireless media, such as cables, telephone lines, power lines, optical fibers, radio waves, and/or light beams, etc., to share resources (such as printers and/or memory devices), exchange files, and/or allow electronic communications therebetween. A network can be and/or can utilize any of a wide variety of sub-networks and/or protocols, such as a circuit switched, public-switched, packet switched, connection-less, wireless, virtual, radio, data, telephone, twisted pair, POTS, non-POTS, DSL, cellular, telecommunications, video distribution, cable, terrestrial, microwave, broadcast, satellite, broadband, corporate, global, national, regional, wide area, backbone, packet-switched TCP/IP, IEEE 802.03, Ethernet, Fast Ethernet, Token Ring, local area, wide area, IP, public Internet, intranet, private, ATM, Ultra Wide Band (UWB), Wi-Fi, BlueTooth, Airport, IEEE 802.11, IEEE 802.11a, IEEE 802.11b, IEEE 802.11g, X-10, electrical power, multi-domain, and/or multi-zone sub-network and/or protocol, one or more Internet service providers, one or more network interfaces, and/or one or more information devices, such as a switch, router, and/or gateway not directly connected to a local area network, etc., and/or any equivalents thereof.
network interface—any physical and/or logical device, system, and/or process capable of coupling an information device to a network. Exemplary network interfaces comprise a telephone, cellular phone, cellular modem, telephone data modem, fax modem, wireless transceiver, communications port, ethernet card, cable modem, digital subscriber line interface, bridge, hub, router, or other similar device, software to manage such a device, and/or software to provide a function of such a device.
NFT—a nonfungible token.
nonfungible token—assets on blockchain with unique identification codes and metadata that distinguish each from any other.
packet—a generic term for a bundle of data organized in a specific way for transmission, such as within and/or across a network, such as a digital packet-switching network, and comprising the data to be transmitted and certain control information, such as a destination address.
perceptible—capable of being perceived by the human senses. physical—tangible, real, and/or actual.
physically—existing, happening, occurring, acting, and/or operating in a manner that is tangible, real, and/or actual. plurality—the state of being plural and/or more than one.
predetermined—established in advance.
privileges—permissions, access, entitlement, exclusivity and/or similar rights including but not limited to rights associated to club and/or community membership and including but not limited to digital rights.
probability—a quantitative representation of a likelihood of an occurrence.
processor—a hardware, firmware, and/or software machine and/or virtual machine physically adaptable to perform, via boolean logic operating on a plurality of logic gates, a specific task defined by a set of machine-implementable instructions. A processor can utilize mechanical, pneumatic, hydraulic, electrical, magnetic, optical, informational, chemical, and/or biological principles, mechanisms, adaptations, signals, inputs, and/or outputs to perform the task(s). In certain embodiments, a processor can act upon information by manipulating, analyzing, modifying, and/or converting it, transmitting the information for use by machine-implementable instructions and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium family of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein. A processor can reside on and use the capabilities of a controller.
programmatically—using one or more algorithms, procedures, calculations, macros, software programs, machine instructions and/or other such utilities adapted for such purpose, including but not limited to those installed on a server and/or information device.
project—to calculate, estimate, or predict.
provide—to furnish, supply, give, and/or make available.
receive—to get as a signal, take, acquire, and/or obtain.
recommend—to suggest, praise, commend, and/or endorse.
render—to make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, etc.
repeatedly—again and again; repetitively.
request—to express a desire for and/or ask for.
second device user—user of the second information device.
select—to make a choice or selection from alternatives.
server—an information device and/or a process running thereon, that is adapted to be communicatively coupled to a network and that is adapted to provide at least one service for at least one client, i.e., for at least one other information device communicatively coupled to the network and/or for at least one process running on another information device communicatively coupled to the network. One example is a file server, which has a local drive and services requests from remote clients to read, write, and/or manage files on that drive. Another example is an e-mail server, which provides at least one program that accepts, temporarily stores, relays, and/or delivers e-mail messages. Still another example is a database server, which processes database queries. Yet another example is a device server, which provides networked and/or programmable: access to, and/or monitoring, management, and/or control of, shared physical resources and/or devices, such as information devices, printers, modems, scanners, projectors, displays, lights, cameras, security equipment, proximity readers, card readers, kiosks, POS/retail equipment, phone systems, residential equipment, HVAC equipment, medical equipment, laboratory equipment, industrial equipment, machine tools, pumps, fans, motor drives, scales, programmable logic controllers, sensors, data collectors, actuators, alarms, annunciators, and/or input/output devices, etc.
set—a related plurality.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
special purpose computer—a computer and/or information device comprising a processor device having a plurality of logic gates, whereby at least a portion of those logic gates, via execution of specific machine instructions by the processor, experience a change in at least one physical and measurable property, such as a voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc., thereby directly tying the specific machine instructions to the logic gate's specific configuration and property(ies). In the context of an electronic computer, each such change in the logic gates creates a specific electrical circuit, thereby directly tying the specific machine instructions to that specific electrical circuit.
special purpose processor—a processor device, having a plurality of logic gates, whereby at least a portion of those logic gates, via execution of specific machine instructions by the processor, experience a change in at least one physical and measurable property, such as a voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc., thereby directly tying the specific machine instructions to the logic gate's specific configuration and property(ies). In the context of an electronic computer, each such change in the logic gates creates a specific electrical circuit, thereby directly tying the specific machine instructions to that specific electrical circuit.
store—to place, hold, and/or retain data, typically in a memory.
substantially—to a great extent or degree.
system—a collection of mechanisms, devices, machines, articles of manufacture, processes, data, and/or instructions, the collection designed to perform one or more specific functions.
system user—an administrative and/or system-level user with appropriate permissions in a system.
transform—to change in measurable: form, appearance, nature, and/or character.
transmit—to send as a signal, provide, furnish, and/or supply.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
via—by way of and/or utilizing.
weight—a value indicative of importance.

### Notes

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise: there is no requirement for the inclusion of any particular described or illustrated characteristic, function, activity, or element, any particular sequence of activities, or any particular interrelationship of elements; no characteristic, function, activity, or element is “essential”; any elements can be integrated, segregated, and/or duplicated; any activity can be repeated, any activity can be performed by multiple entities, and/or any activity can be performed in multiple jurisdictions; and any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A method comprising:
from a server, sending club search software to a first information device, the software adapted to enable the user of the first information device to input one or more search parameter values; via said server, creating a communication session linking said first information device to said server; at said server, from said club search software running on said first information device, receiving data associated with said search parameter values.

2. The method of claim 1, further comprising:
club search server software running on said server, the software adapted to receive data associated with said search parameter values.

3. The method of claim 2, further comprising:
said server software adapted to validate such data using one or more validation rules.

4. The method of claim 3, further comprising:
in response to one or more failures of such validation tests, said software adapted to change any such data associated with such failures in a manner that enables such data associated with such failures to pass such validation tests.

5. The method of claim 2, further comprising:
said server software adapted to create a validation pattern using as input data associated with said search parameter values.

6. The method of claim 5, further comprising:
said server software adapted to validate such validation pattern using one or more validation rules.

7. The method of claim 6, further comprising:
upon validation of said validation pattern, said server software adapted create a club identifier using as input data associated with said search parameter values.

8. The method of claim 7, further comprising:
said server software adapted to create a club using as input data said club identifier.

9. The method of claim 2, further comprising:
said server software adapted to retrieve data associated with a club using as input data associated with said search parameter values.

10. The method of claim 9, further comprising:
at said first information device, from said server, receiving data associated with said club.

11. The method of claim 10, further comprising:
said server software adapted to retrieve data associated with one or more NFTs associated with said club.

12. The method of claim 11, further comprising:
said server software adapted to set a minimum price for the first such NFT associated with said club.

13. The method of claim 12, further comprising:
said server software adapted to sell said first such NFT associated with said club for a price greater than or equal to said minimum price for said first such NFT.

14. The method of claim 13, further comprising:
said server software adapted to programmatically set a minimum price for the second such NFT associated with said club using as input the sale price of said first such NFT associated with said club.

15. The method of claim 14, further comprising:
said server software adapted to sell said second such NFT associated with said club for a price greater than or equal to said minimum price for said second such NFT.

16. The method of claim 15, further comprising:
said server software adapted to programmatically set a minimum price for the third such NFT associated with said club using as input the sale price of said second such NFT associated with said club.

17. The method of claim 16, further comprising:
said server software adapted to sell said first such NFT associated with said club for a price greater than or equal to said minimum price for said third such NFT.

18. The method of claim 17, further comprising:
said server software adapted to programmatically reset said minimum price for said third such NFT associated with said club using as input the resale price of said first such NFT associated with said club.
